(19) United States
(12) Patent Application Publication
(10) Pub. No.: US 2025/0115348 A1
(43) Pub. Date: Apr. 10, 2025

(54) Mechanism of Wing Root Shifting in Variable Sweep Wing Aircraft

(71) Applicant: Jincheng Luo, Toronto (CA)

(72) Inventor: Jincheng Luo, Toronto (CA)

(21) Appl. No.: 18/797,105

(22) Filed: Aug. 7, 2024

(51) Int. Cl. B64C 3/40

(52) U.S. Cl. CPC B64C 3/40

(57) ABSTRACT

This invention fixes a center of lift shift in variable sweep wing aircraft, by allowing the wing root to shift forwards or backwards. This will allow for the aircraft to travel faster without the problems from changing the center of lift.

### BACKGROUND

Historically, people have had a hard time making aircraft travel faster. When taking off, aircraft start with no speed and need to accelerate. As a result, they fly slowly at first. During low speed flight, a longer wingspan would be needed to generate enough lift for the aircraft. However, eventually the aircraft will pick up speed. When we want an aircraft to fly at high speeds, a shorter wingspan would be favourable as it provides less air resistance allowing it to travel faster. One solution people in the past came up with is the variable swept wing. However, a variable swept wing comes with problems such as the center of lift being backwards, off the center of mass. This would cause a torque on the body of the aircraft and would hinder stable flights. This invention fixes the problem of the center of lift being shifted backwards.

### DESCRIPTION

This invention allows aircraft to adjust their wing geometry to fly faster without shifting their center of lift. It involves the shifting of the wing root forwards and backwards. When the variable swept wing sweeps backwards, the wing root will shift forward, allowing for the center of lift to stay in place. It does not matter what mechanism is used to shift the wing root back and forth.

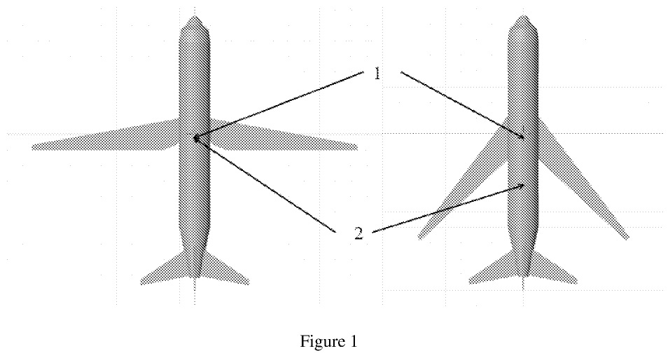

FIG. 1 is an aircraft with normal variable swept wings. On the left side of the diagram, the aircraft's wings are in their low-speed configuration. The center of lift (labelled 2) coincides with the center of mass (labelled 1). On the right of the diagram, the aircraft's wings are in their high-speed configuration. The wings are swept back, and the center of lift (labelled 2) is shifted backwards with the wings. As a result, it no longer coincides with the center of mass (labelled 1).

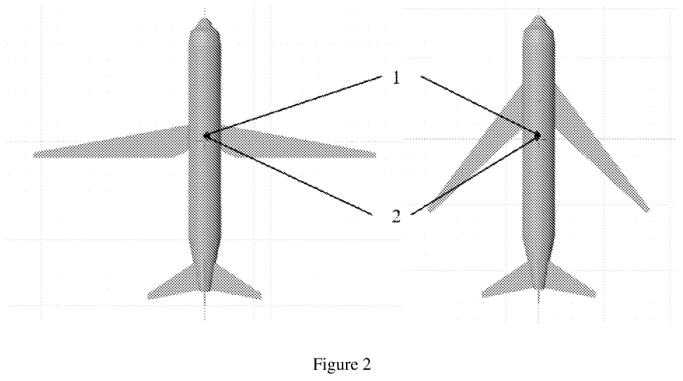

FIG. 2 is an aircraft that demonstrates our invention. On the left side of the diagram, the aircraft's wings are in their low-speed configuration. The center of lift (labelled 2) coincides with the center of mass (labelled 1). On the right side of the diagram, the aircraft's wings are in their high-speed configuration. However, this time, the wing root has shifted forwards and the center of lift (labelled 2) coincides with the center of mass (labelled 1).

1) The mechanism that involves the moving of the wing root forward or backward during wing sweep in order to prevent the shifting of the center of lift, no matter what technique is used to move them such as using sliding rails or different pivot point connections on the wings and fuselage.
